(19) United States
(12) Patent Application Publication
(10) Pub. No.: US 2005/0091085 A1
(43) Pub. Date: Apr. 28, 2005

(54) Method for evaluating the value of group and individual insurance products

(76) Inventors: John Lawrence Colley, Richmond, VA (US); Ronald Hampton Bargatze, Richmond, VA (US); Timothy Gerard O'Shea, Richmond, VA (US)

Correspondence Address: John H. Thomas, P.C., 536 Granite Avenue, Richmond, VA, 23226, US

(21) Appl. No.: 11/005,159

(22) Filed: Dec. 6, 2004

Related U.S. Application Data
(63) Continuation-in-part of application No. 10/691,762, filed on Oct. 23, 2003.
(60) Provisional application No. 60/528,153, filed on Dec. 9, 2003.

(51) Int. Cl. G06F 17/60

(52) U.S. Cl. 705/4

(57) ABSTRACT

A method relates to the assessment and selection of group and individual insurance products. The method includes the relative valuation of diverse contractual attributes and the syntheses of these relative valuations into a Value Index for each insurance product being evaluated. The analysis method can be used for the assessment and comparison of various lines of voluntary or contributory group insurance products (as well as individual insurance products), including but not limited to Long-Term Disability (LTD), Short-Term Disability (STD), Life, Dental, Accidental Death and Dismemberment (AD&D), and Long-Term Care (LTC).

This application claims the benefit of filing of U.S. Provisional Patent Application No. 60/528,153, filed on Dec. 9, 2003, which is incorporated by reference herein as if set forth in its entirety.

This application is a continuation in part of U.S. patent application Ser. No. 10/691,762, filed Oct. 23, 2003, which is incorporated by reference herein as if set forth in its entirety.

The present invention relates to the assessment and selection of group and individual insurance products. The method includes the relative valuation of diverse contractual attributes and the synthesis of these relative valuations into a Value Index for each insurance product being evaluated. The analysis method can be used for the assessment and comparison of various lines of voluntary or contributory group insurance products (as well as individual insurance products), including but not limited to Long-Term Disability (LTD), Short-Term Disability (STD), Life, Dental, Accidental Death and Dismemberment (AD&D), and Long-Term Care (LTC). In each case, the present method reduces complex product comparisons to a simple comparison of Value Indices.

### BACKGROUND

At present, agents, brokers, or carrier marketing representatives typically present consumers with a menu of insurance product coverage options. Consumers are either individuals or group decision makers (GDMs) for employer-based plans. Options entail carriers, products, and myriad benefit design features (e.g., definitions, exclusions, waiting periods, benefit levels, etc.). The decision maker generally is presented with a set of choices within each insurance line, each with a price plus dozens of benefit design attributes that influence the quality of coverage. Because contractual benefit provisions are so complex and multifaceted, it is very difficult for the consumer to characterize quality of coverage. Therefore, premiums, which are easily discernible and understood, typically drive the decision-making process.

Industry-standard practice is to present all of the important product attributes in the form of tables or lists. Top consultants distinguish themselves from their competition by presenting longer or more complete lists. These lists and tables of plan attributes can account for scores of pages in documents that present market options to the GDM. The problem with this approach is that no human brain can assimilate and integrate all of these features into an accurate and meaningful characterization of value (the most coverage for the money). Qualitative impressions of quality are generally formed from a handful of attributes that the decision maker happens to notice or emphasize. In the industry-standard decision-making process, only price is quantitatively assessed. Value, or price relative to quality, is relegated to the realm of qualitative impression, because the quality component of the value consideration can only be characterized in a qualitative way.

### DESCRIPTION OF METHODS

The present method of insurance product evaluation differs from all previous methods by virtue of one or more of the following: its quantitative nature, its underlying mathematical models and algorithms, and its synthesis of disparate issues and attributes. The analysis method can be used for the assessment and comparison of various lines of contributory group or non-contributory insurance products (as well as individual insurance products), including but not limited to Long-Term Disability (LTD), Short-Term Disability (STD), Life, Dental, Accidental Death and Dismemberment (AD&D), and Long-Term Care (LTC). The method provides decision makers for group insurance plans with information not previously available to them. One example of the method does this through what is referred to herein as the VALUE SELECT^{SM} method. The VALUE SELECT^{SM} method provides for each insurance product to be considered in terms of a single value index (indicative of the most coverage for the money).

The VALUE SELECT^{SM} method compares insurance products to one another on the basis of value (coverage for the money) by means of a value index that is calculated for each product assessed. For each insurance option evaluated, a value index is calculated. Indices represent value relative to a standard value of 1.0. In most cases, renewal of the incumbent product is taken as the standard for comparison, but any insurance product could be selected as the standard. In the example of an incumbent plan used as a standard, the renewal premium for the incumbent plan's set of benefits becomes the expected premium for that particular set of benefits. Its value index is defined as 1.0. Each alternative to renewal of the incumbent product (or other standard product) receives a value index that reflects the ratio of its expected premium cost to its actual premium cost. A higher value index, (i.e., higher ratio of expected premium to actual premium) indicates a better value, or more coverage for the money.

Expected premiums for each alternative product reflect the assumption that each departure in contractual benefit from the index (or reference) product should be accompanied by a corresponding premium departure. The VALUE SELECT^{SM} method identifies contractual attributes (variables) that influence value, and ascribes a specific relative premium factor (SRPF) to variations in values of each attribute. Variables and their associated SRPFs may be either categorical or continuous. SRPFs are determined by a variety of empirical, statistical and research methods. For each product, the SRPFs are multiplied together to derive the product's overall relative premium factor (RPF). The expected premium for each product is calculated as its RPF divided by the reference product's RPF, and then multiplied by the reference product's premium. The Value Index for each product is calculated as the ratio of expected premium to actual premium. The VALUE SELECT^{SM} method for each line of insurance uses this same fundamental approach (described above) to derive the expected premium and Value Index.

The VALUE SELECT^{SM} Method for LTD as an Example

To demonstrate the method and business application of the VALUE SELECT^{SM} process, a simplified version of VALUE SELECT^{SM} for LTD (Long-Term Disability) will be presented. As with other insurance lines, value is a function of numerous contractual attributes (variables), in addition to price. The following list identifies many, but not all, of the variables relevant to the determination of value for an LTD insurance product:
Maximum Benefit
Elimination Period
Benefit Percentage
Definition of Disability
Integration Type
Offset Type
Pre-Existing Condition
Survivor Benefit
Drug and Alcohol Provisions
Mental and Nervous Provisions
COLA
Zero Day Residual
Prior Coverage
Rate Guarantee
Non-ERISA
Mandatory Rehabilitation
Pension contribution
Pension contribution—dollar maximum
Pension contribution—time maximum
Own occupation earnings test
Any occupation earnings test
“Or” vs. “And” definition of Disability
Maximum Benefit Period
Maximum Benefit Duration
Subjective symptom limitation
Return-to-work incentive benefit
Rehabilitation benefit
Child care benefit
Total benefit cap
Waiver of premium
Minimum benefit
Offset formula (working benefit calculation)
Deductible sources of income
Recurrent disability provision
Temporary recovery
Continuity of coverage (No loss/no gain)
ADL-based rider for supplemental payments
Accumulation period
Interruption period (e.g. “unlimited”)
Maternity

Some variables are dichotomous (e.g., mandatory rehabilitation), some are categorical (e.g., elimination period), and some are continuous (e.g., maximum benefit). Specific relative premium factors (SRPFs) for most dichotomous and categorical variables are determined in VALUE SELECT^{SM} by lookup tables, and SRPFs for continuous variables are calculated by formulas or algorithms. Lookup values are determined a priori (and lookup tables constructed) by one or more of following three methods: 1. When asked, carriers may volunteer pricing factors for isolated variables, 2. Multiple quotes that isolate particular variables may be requested from a single carrier for a single group, and 3. A large database of quotes and contracts permits the determination of SRPFs by methods such as multivariate regression analysis and analysis of variance.

To illustrate the method, a grossly simplified example will be presented. Renewal of a group's current LTD coverage (at a new, higher rate than the previous year's) will be compared to an option B that has both a different premium and different contractual benefits. For simplicity, we will assume that the contractual benefits of the renewal product and option B differ from one another only with respect to three attributes (maximum benefit, elimination period, and benefit percentage), and are in all other respects equivalent. The products are summarized in Table 1, below.

TABLE 1
Benefit Summary for Simplified VALUE SELECT^{SM} Demonstration

| | Current | A (Renewal) | B |
|---|---|---|---|
| Premium | $0.538 | $0.820 | $0.770 |
| Max Benefit | $10,000 | $10,000 | $8,000 |
| Elimination Period (Days) | 180 | 180 | 150 |
| Benefit Percentage | 66.7% | 66.7% | 60.0% |

Given the premium and the contractual benefits, the relevant business question is which product represents the better value (note that premium is presented as typically quoted, cost per $100 of payroll). Option B has a lower premium, but is it a better value? Said another way, is the decrement in premium what one would expect given the departures in contractual benefit? Option B's lower Maximum Benefit and Benefit Percentage should be associated with lower premium, but its shorter Elimination Period (time the beneficiary must be disabled before payments ensue) would justify a higher premium. What is the net effect of contract differences on expected premium and value? The answer to this question has not heretofore been quantifiable in broker/consultant/customer interactions, but VALUE SELECT^{SM} provides the answer.

The VALUE SELECT^{SM} process approaches aggregate premium value by determining the specific premium value of each benefit design feature (variable), and then multiplying them by one another. For example, consider a product B that differs from product A with respect to attribute X, in a manner associated with an expected 5% increase in premium. If B also differs from A with respect to attributes Y and Z, which have independent (specific) relative values of 10% and 15%, respectively, then the expected price of B is 105%*110%*115%, or 133% of A's price (33% higher than A).

For the example of VALUE SELECT^{SM} for Long-Term Disability (LTD), the specific relative premium factor (SRPF) for each attribute must be determined before the overall relative premium factor (RPF), expected premium, and Value Index can be calculated. In the example, one attribute (Benefit Maximum) will be calculated based on group-specific data, and two (Elimination Period and Benefit Percent) will be determined by looking-up previously determined values. The calculation of SRPF values for the Benefit Maximum attribute is presented below in Table 2. Note that the calculation requires employee-level payroll data. This data set is typically available to the broker/consultant as intermediary in the quoting process. (Since the benefit covers lost wages, carriers require payroll data to underwrite.) For simplicity, the Table 2 example is for a company with only 10 employees (A-J), only one of whom is highly-compensated enough to be adversely affected by the Benefit Maximum. This employee earns $200,000 annually, which means the potential benefit payment for product A (66.7% Benefit Percentage) is $133,400, and for product B (60% Benefit) is $120,000. However, neither of these potential payouts can be realized, because they exceed the contractual Benefit Maxima. The maximum for A is $120,000 ($10,000 per month*12 months per year) and for B is $96,000 ($8,000*12 months).

TABLE 2
Calculation of Specific Relative Premium Factors for Benefit Maxima

| | | A | A | A | B | B | B |
|---|---|---|---|---|---|---|---|
| Employee | Salary | Benefit | Maximum | Trimmed | Benefit | Maximum | Trimmed |
| A | $200,000 | $133,400 | $120,000 | −$13,400 | $120,000 | $96,000 | −$24,000 |
| B | $140,000 | $93,380 | $120,000 | $0 | $84,000 | $96,000 | $0 |
| C | $60,000 | $40,020 | $120,000 | $0 | $36,000 | $96,000 | $0 |
| D | $55,000 | $36,685 | $120,000 | $0 | $33,000 | $96,000 | $0 |
| E | $41,000 | $27,347 | $120,000 | $0 | $24,600 | $96,000 | $0 |
| F | $40,000 | $26,680 | $120,000 | $0 | $24,000 | $96,000 | $0 |
| G | $29,000 | $19,343 | $120,000 | $0 | $17,400 | $96,000 | $0 |
| H | $27,000 | $18,009 | $120,000 | $0 | $16,200 | $96,000 | $0 |
| I | $24,000 | $16,008 | $120,000 | $0 | $14,400 | $96,000 | $0 |
| J | $23,000 | $15,341 | $120,000 | $0 | $13,800 | $96,000 | $0 |
| Total | $639,000 | $426,213 | | −$13,400 | $383,400 | | −$24,000 |
| SRPF | | | | −3.1% | | | −6.3% |

As is seen in Table 2, the Benefit Maximum trims the potential value of product A by $13,400, which is 3.1% of the $426,213 potential value of the product. Similarly, B is trimmed by $24,000, which is 6.3% of its potential value. The SRPF for A is 3.1% and for B is 6.3%. The implication is that A should cost 96.9% (100%−3.1%) of what it would otherwise cost without the $10,000 per month cap on benefits. Similarly, B should cost 93.7% of what it would cost without its $8,000 per month maximum.

Note that the SRPF determination above assumes a linear relationship between Benefit Maximum (implicitly also Benefit Percentage) and carrier liability. In reality, an individual's propensity to claim disability is influenced by the available disability compensation, and the incremental carrier liability associated with an increasing benefit level is greater than a linear model would predict. For illustration of this point, refer to Table 4 and note that a benefit level of 66.7% (11% higher than a 60% benefit level) is associated with a premium 35% higher than that expected for a 60% benefit. To adjust for this non-linearity, the VALUE SELECT^{SM} method allows certain SRPFs to be multiplied by a behavioral adjustor. A reasonable adjustor for the Table 2 example is suggested by the ratio of benefit difference to expected premium difference. For product A (the reference product) the multiplier would be 1.0 and for B it would be 0.82 (1.11 divided by 1.35). Therefore, for ultimate comparison to A, B's SRPF would be adjusted in VALUE SELECT^{SM} from 6.3% to 5.2% (0.82 times 6.3%).

Next, the SRPF values for Elimination Period and Benefit Percent must be determined. As is the case for many variables in the VALUE SELECT^{SM} method, the relative premiums associated with these attributes are not group-specific. They are determined by various means (described below) and compiled into lookup tables in the VALUE SELECT^{SM} process. Values in these tables are derived by consultation with carrier actuaries and underwriters, by systematically requesting quotes that supply table values, or by statistical analysis (e.g., multivariate logistic regression and analysis of variance) of a database of quoted benefits and premiums. SRPF lookup tables for Elimination Period and Benefit Percent are given in Tables 3 and 4, respectively.

TABLE 3
SRPF Lookup Table for Elimination Period

| Elimination | |
|---|---|
| Period (Days) | SRPF |
| 360 | −11.8% |
| 270 | −3.8% |
| 180 | 0.0% |
| 150 | 5.9% |
| 120 | 10.9% |
| 90 | 17.4% |
| 60 | 25.6% |
| 30 | 37.9% |

TABLE 4
SRPF Lookup Table for Benefit Percentage

| Benefit | |
|---|---|
| Percentage | SRPF |
| 66.7% | 35.0% |
| 60.0% | 0.0% |
| 50.0% | −27.1% |
| 40.0% | −40.3% |

Note that each attribute has a typical (default or base-case) value that is associated with a SRPF of zero. For example, the base-case product has an Elimination Period of 180 days and has a premium (100%+0%) equal to the base-case premium. Table 3 tells us that we expect an otherwise equivalent product with a 150 day Elimination Period to cost 5.9% more than the base-case product. Table 4 tells us that a Benefit Percentage of 66.7% increases expected premium by 35%, relative to a 60% Benefit Percentage. After determining the specific relative premium factors associated with each contractual attribute, the overall relative premium factor, expected premium, and value index can be derived for each product. The process is illustrated in Table 5, below.

TABLE 5
Value Index Calculation

| | Current | A (Renewal) | B |
|---|---|---|---|
| Premium | $0.538 | $0.820 | $0.770 |
| | Benefit | Benefit | Benefit |
| Maximum Benefit | $10,000 | $10,000 | $8,000 |
| Elimination Period | 180 | 180 | 150 |
| (Days) | | | |
| Benefit Percent | 66.7% | 66.7% | 60.0% |
| | SRPF | SRPF | SRPF |
| Maximum Benefit | N/A | −3.1% | −5.2% |
| Elimination Period | N/A | 0.0% | 5.9% |
| (Days) | | | |
| Benefit Percent | N/A | 35.0% | 0.0% |
| | 1 + SRPF | 1 + SRPF | 1 + SRPF |
| Maximum Benefit | N/A | 96.9% | 94.8% |
| Elimination Period | N/A | 100.0% | 105.9% |
| (Days) | | | |
| Benefit Percent | N/A | 135.0% | 100.0% |
| | | PROD(1 + SRPF) | PROD(1 + SRPF) |
| | | 130.8% | 100.4% |
| RPF | | 30.8% | 0.4% |
| Actual Premium | | $0.820 | $0.770 |
| Expected Premium | | $0.820 | $0.629 |
| Value Index | | 1.00 | 0.82 |

Table 5 summarizes premiums and contractual benefits for products A (renewal of the current product at a new, higher premium) and B. SRPF values as derived and discussed above are displayed (note that the adjusted SRPF is used for Benefit Maximum). For each product, the individual SRPF values (plus unity) are multiplied together to yield PRODUCT(1+SRPF). The results are 130.8% for product A and 100.4% for product B. These values (minus unity) represent the overall relative premium factors (RPF) for the two products (30.8% and 0.4%, respectively). The expected premium for each product is the premium for the reference product (generally taken in VALUE SELECT^{SM} to be the renewed incumbent product) multiplied by one plus the RPF for the product in question, and divided by one plus the RPF for the reference product. For product B, the expected premium of $0.629 per $100 of payroll is the rate that would make B an equal value to A, given its leaner benefits. Since the actual premium of $0.770 is substantially higher, we know that B is an inferior value to A. The extent of B's deficiency is quantified by the Value Index, which is the ratio of expected premium to actual premium. In the example presented, the value index for A is 1.00 (by definition as the reference plan) and the value index for B is a substantially inferior 0.82. (In the parlance of VALUE SELECT^{SM}, B is 18 value points inferior to A).

The VALUE SELECT^{SM} process addresses a common and problematic situation faced by individuals purchasing insurance, and by businesses that purchase group insurance products for their employees. How does one differentiate better values from worse values when options differ from one another in multiple and complex ways? The VALUE SELECT^{SM} method offers a unique, original, quantitative approach to this problem by systematically assessing the impact of each contractual difference between products, and then generating an expected premium and value index for each product.

While the invention has been described with reference to specific embodiments thereof, it will be understood that numerous variations, modifications and additional embodiments are possible, and all such variations, modifications, and embodiments are to be regarded as being within the spirit and scope of the invention.

1. A method for comparing insurance products comprising the steps of:
selecting a standard insurance product and assigning a standard value to the standard product;
selecting an alternative insurance product;
calculating a value index for the alternative product;
using the value index to compare the alternative and standard insurance products.

2. A method as described in claim 1, further comprising selecting a plurality of alternative insurance products, calculating a value index for each of the alternative insurance products, and using each of the calculated value indices to compare each of the alternative and standard insurance products.

3. A method as described in claim 1, wherein the standard insurance product is an incumbent insurance product.

4. A method as described in claim 1, wherein the value index equals the ratio of an expected premium for the alternative product to an actual premium for the alternative product.

5. A method as described in claim 1, wherein the value index is a single number.

6. A method as described in claim 1, wherein the insurance products are selected from the group consisting of Long-Term Disability (LTD), Short-Term Disability (STD), Life, Dental, Accidental Death and Dismemberment (AD&D), and Long-Term Care (LTC).

7. A method as described in claim 1, wherein the step of calculating a value index comprises identifying a contractual attribute of the product that influences value and ascribing a specific relative premium factor to variations in value of the attribute.

8. A method as described in claim 7, further comprising a plurality of contractual attributes and a corresponding plurality of specific relative premium factors.

9. A method as described in claim 7, further comprising multiplying the specific relative premium factor by a behavioral adjustor.

10. A method as described in claim 8, further comprising multiplying one of the specific relative premium factors by a behavioral adjustor.
